(19) United States
(12) Patent Application Publication
(10) Pub. No.: US 2020/0096018 A1
(43) Pub. Date: Mar. 26, 2020

(54) JET-FLAPPER SERVO VALVE

(71) Applicant: Hamilton Sundstrand Corporation, Charlotte, NC (US)

(72) Inventor: Zbigniew JASKIEWICZ, Wroclaw (PL)

(21) Appl. No.: 16/533,020

(22) Filed: Aug. 6, 2019

(30) Foreign Application Priority Data
Sep. 26, 2018 (EP) 18461613.4

(51) Int. Cl. F15B 13/043

(52) U.S. Cl. CPC F15B 13/0438

(57) ABSTRACT

A hydraulic servo valve is provided. The servo valve comprises a fluid injection cavity and at least one fluid injection opening disposed in the cavity that is configured to supply fluid to the cavity. A pair of fluid receiving openings is disposed in the cavity, and a member is disposed between the pair of openings. The member is bendable and/or rotatable in order to selectively open or occlude each of the openings.

### FOREIGN PRIORITY

This application claims priority to European Patent Application No. 18461613.4 filed Sep. 26, 2018, the entire contents of which is incorporated herein by reference.

### TECHNICAL FIELD

This disclosure relates generally to a hydraulic servo valve. This disclosure also relates to a method of controlling an actuator using a hydraulic servo valve.

### BACKGROUND

Servo valves are generally used when accurate position control is required, such as, for example, control of a primary flight surface. Servo valves can be used to control hydraulic actuators or hydraulic motors. They are common in industries which include, but are not limited to, automotive systems, aircraft and the space industry.

A known type of hydraulic servo valve is a jet pipe arrangement. Another known type of hydraulic servo valve is a flapper and nozzle arrangement.

FIG. 1 shows generally a known arrangement of a jet pipe hydraulic servo valve 10. The hydraulic servo valve 10 shown in FIG. 1 represents a jet pipe type arrangement as discussed above. The primary components of the jet pipe type arrangement are a jet tube 101 for receiving a supply pressure, an armature 102 connected to the jet pipe 101, and an electromagnet 105 surrounding the armature 102. In known arrangements, the jet pipe 101 and the armature 102 are separate components. An electrical input (not shown) is connected to the electromagnet 105. When an electrical current is supplied to the electromagnet 105, the armature 102 changes position due to electromagnetic forces supplied by the electromagnet 105. The jet pipe arrangement shown in FIG. 1 is contained within a housing 106.

In the example shown, the armature 102 is connected in a perpendicular manner to the jet pipe 101, or is an integral part of the jet pipe 101—the integral part being perpendicular to the jet pipe 101. The electromagnet 105 provides a torque that is proportional to the electrical current that is provided by the electrical input. The electromagnet 105 includes coils (not shown) that surround the armature 102 and a set of permanent magnets (not shown) that surround the coils. When a current is applied to the coils, magnetic flux acting on the ends of the armature 102 is developed. The direction of the magnetic flux (force) depends on the sign (direction) of the current. The magnetic flux will cause the armature tips 102a, 102b to be attracted to the electromagnet 105 (current direction determines which magnetic pole is attracting and which one is repelling). This magnetic force creates an applied torque on the jet pipe 101, which is proportional to applied current. The jet pipe 101 rotates and interacts with a spool portion (shown generally as 107 in FIG. 1).

The primary components of the spool portion 107 are receivers 108a and 108b that are in fluid communication with chambers 104a and 104b. There is also provided a spool 103 which is movable between chambers 104a and 104b. The movement of the spool 103 is accurately controlled by the jet pipe 101 and the pressure provided in chambers 104a and 104b.

The hydraulic servo valve 10 also includes a supply pressure inlet flexible tube 111 connected to a supply pressure inlet 109 that provides fluid into the flexible tube 111. The fluid passes through a filter 112 and then through jet pipe 101. At the end of the jet pipe 101 is a nozzle 113.

In use, the jet pipe 101 converts kinetic energy of moving fluid into static pressure. When the jet pipe 101 is centred between the receivers 108a and 108b, the pressure on the spool 103 is equal. However, when the jet pipe 101 is rotated by the armature 102 and electromagnet 105 toward one of the receivers—say 108a, the pressure at this receiver 108a is greater than the other receiver 108b. This creates a load imbalance on the spool 103 causing it to move. If, for example, the jet pipe 101 is rotated toward the receiver 108a, this could cause the spool 103 to move to the right and into chamber 104b, as the pressure would be greater in chamber 104a, and the pressure would be decreased in chamber 104b. As the spool 103 moves from a null position—i.e., when the pressure is equal in chambers 104a and 104b. Outlets 110a and 110b in fluid communication with the spool 103 and chambers 104a, 104b then communicate the pressure imbalance to control an actuator (not shown). The actuator part of the servo valve has the same characteristics as any known hydraulic actuator.

FIG. 2 shows generally a known arrangement of a flapper and nozzle hydraulic servo valve 20. Servo valve 20 comprises an electromagnet 205 and armature 202 as discussed in relation to FIG. 1, and like features have been represented with the same numeral, but prefixed with “2xx” instead of “1xx”. Servo valve 20 also comprises a flapper 201 disposed in a flapper cavity 208c, and a pair of nozzles 206 disposed in a nozzle housing 208.

In the same manner as the jet pipe servo valve 10 described above in relation to FIG. 1, the electromagnet 205 is connected to an electrical input (not shown) and applies a torque to the armature 202 (including armature tips 202a, 202b) which is connected to or is integral with the flapper 201 that is perpendicular thereto. In this manner, the torque applied to the armature 202 causes the flapper 201 to rotate and interact with the nozzles 206.

Nozzles 206 are housed within a nozzle housing 208 in a respective nozzle cavity 210, and comprise a fluid outlet 206a and fluid inlet 206b. Housing 208 also has a port 208a, which allows communication of fluid to the nozzles 206. The flapper 201 comprises a blocking element 201a at an end thereof which interacts with fluid outlets 206a of nozzles 206 to provide metering of fluid from the fluid outlets 206a to a fluid port 208b in the housing 208. Fluid port 208b in turn allows communication of fluid pressure downstream to a spool and actuator arrangement (not shown), such as discussed above in relation to FIG. 1.

In a similar manner to the positioning of the jet pipe 101 relative to the receivers 108a and 108b discussed in relation to FIG. 1, the positioning of the flapper 201 between nozzles 206 (controlled by the movement of the armature 202 via electromagnet 205) will control the amount of fluid pressure communicated to the spool and actuator (not shown), which can be used to control the actuator.

Although the type of servo valve arrangements shown in FIGS. 1 and 2 can be effective at controlling an actuator, it has been found that limitations of each type of arrangement nevertheless exist. For example: the flexible tube 111 and jet pipe 101 provide a less compact servo valve; the nozzles 206 must be accurately calibrated to ensure proper operation of the servo valve, which increases the complexity of servo valve assembly and cost; the force needed to provide flapper 201 movement between nozzles 206 does not vary linearly. Moreover, there is also a general desire to reduce servo valve weight and simplify its construction and operation, as well as improve the operational pressures and frequencies that may be realised with such servo valve arrangements.

The present disclosure aims to provide a servo valve that combines aspects of both the prior art jet pipe and flapper and nozzle servo valve arrangements to overcome some of the above limitations. As such, a servo valve of the present disclosure may be referred to as a “jet-flapper” servo valve.

### SUMMARY

The present disclosure relates to a hydraulic servo valve. The servo valve comprises a fluid injection cavity, at least one fluid injection opening disposed in the cavity and configured to supply fluid to the cavity, a pair of fluid receiving openings configured to receive fluid from the cavity; and a member disposed in the cavity between the pair of openings. The member is bendable and/or rotatable relative to a longitudinal axis of the cavity in order to selectively, and at least partially open or occlude each of the openings.

In one embodiment of the above hydraulic servo valve, the member comprises a flapper connected and extending perpendicular to an armature. An electromagnet surrounds the armature, and electrical energisation of the electromagnet produces a torque on the armature that bends and/or rotates the flapper.

In any alternative embodiment of the above hydraulic servo valve, the member comprises a piezoelectric element. Electrical energisation of the piezoelectric element is configured to bend the element and provide the aforementioned bend and/or rotation. The piezoelectric element may comprise a piezoelectric bimorph, which may be cantilevered at an axial end thereof. The bimorph may comprise a first material layer and a second material layer sandwiched together. The first material layer comprises a piezoelectric material and the second material layer comprises one of a piezoelectric material or a non-piezoelectric material. Alternatively, instead of having first and second material layers, the piezoelectric element may comprise a first piezoelectric actuator extending axially parallel to a second piezoelectric actuator. In one example, the piezoelectric actuators may be piezoelectric stacks.

In a further embodiment of any of the above hydraulic servo valves, the servo valve further comprises at least one seal positioned between a body of the servo valve and the member to prevent fluid escaping the cavity. The at least one seal may comprise a pair of seals disposed in the cavity and be spaced axially apart relative to the longitudinal axis of the cavity. Additionally, the servo valve may further comprise a drainage line disposed axially between the seals. The drainage line is configured to drain any fluid that is caught between the pair of seals.

The present disclosure also relates to a method of controlling an actuator using the hydraulic servo valve of any of the above embodiments. The method comprises the steps of: supplying fluid to the cavity via the at least one injection opening; communicating the fluid to the fluid receiving openings; bending and/or rotating the member in order to establish a pressure imbalance between the fluid communicated to each of the fluid receiving openings; and communicating the pressure imbalance to an actuator, in order to control movement of the actuator.

In one embodiment of the above method, the step of communicating the pressure imbalance to an actuator comprises the further steps of: communicating the pressure imbalance to a spool located within a spool cavity and between a first spool chamber and a second spool chamber; and communicating the pressure imbalance from the spool cavity to the actuator. In this embodiment, the first spool chamber and the second spool chamber are of varying volume based on the position of the spool within the spool cavity, and the pressure imbalance varies the position of the spool to generate the pressure imbalance in the spool cavity.

In a further embodiment of any of the above hydraulic servo valves, the servo valve further comprises a spool located within a spool cavity between a first spool chamber and a second spool chamber, a supply pressure inlet, and a supply line connecting the supply pressure inlet to the at least one injection opening. In this embodiment, the first spool chamber and the second spool chamber are of varying volume based on the position of the spool within the spool cavity. Also, each opening is fluidly connected to a respective one of the first and second spool chambers such that, in use, when the member is bent and/or rotated, the spool moves within the spool cavity to vary the volume of the first and second spool chambers in response to fluid pressure communicated from the openings.

In a further embodiment of the above hydraulic servo valve, the servo valve further comprises a return line fluidly connected to the first and second spool chambers and the spool cavity, and a nozzle and control orifice disposed in the return line. The nozzle and control orifice are configured to provide a constriction for adjusting a fluid pressure in the return line. The constriction may be adjustable, for example, by the nozzle being adjustable.

### BRIEF DESCRIPTION OF THE DRAWINGS

FIG. 1 shows a known arrangement of a jet pipe servo valve.

FIG. 2 shows a known arrangement of a flapper and nozzle servo valve.

FIG. 3A shows an example of a servo valve in accordance with the present disclosure in a neutral (or null) position.

FIG. 3B shows a magnified view of a portion of the servo valve of FIG. 3A.

FIG. 3C is a cross-sectional view of the servo valve of FIG. 3A along line 1-1.

FIG. 3D is a cross-sectional view of the servo valve of FIG. 3C along line 2-2.

FIG. 3E shows an example of the servo valve of FIG. 3A in a pressure imbalance position.

FIG. 3F shows a magnified view of a portion of the servo valve of FIG. 3E.

FIGS. 4A-4C show a magnified view of a portion of the servo valve of FIG. 3A at a neutral position, a slight pressure imbalance position and a maximum pressure imbalance position, respectively.

FIGS. 5A and 5B show an alternative example of a servo valve in accordance with the present disclosure in a neutral (or null) position.

### DETAILED DESCRIPTION

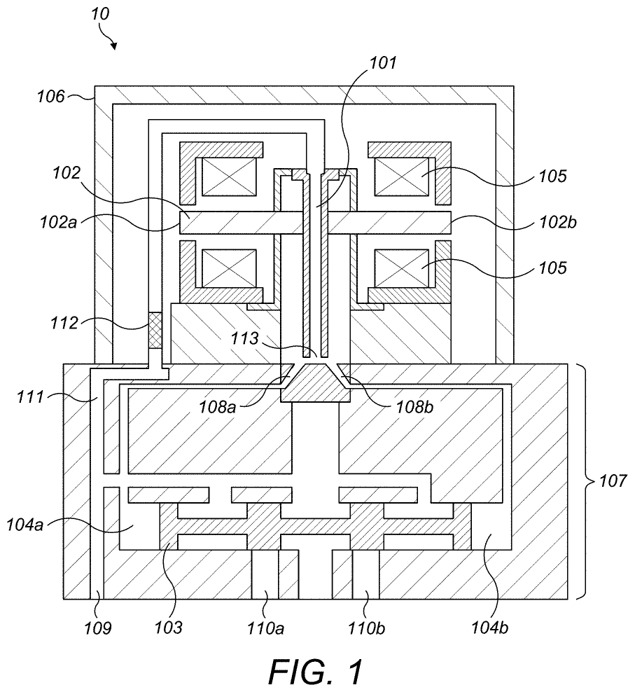

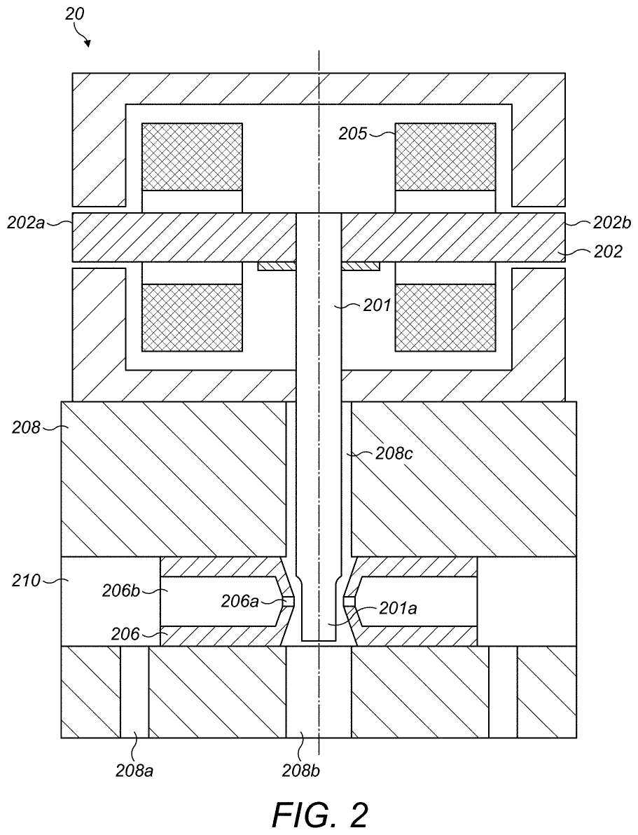

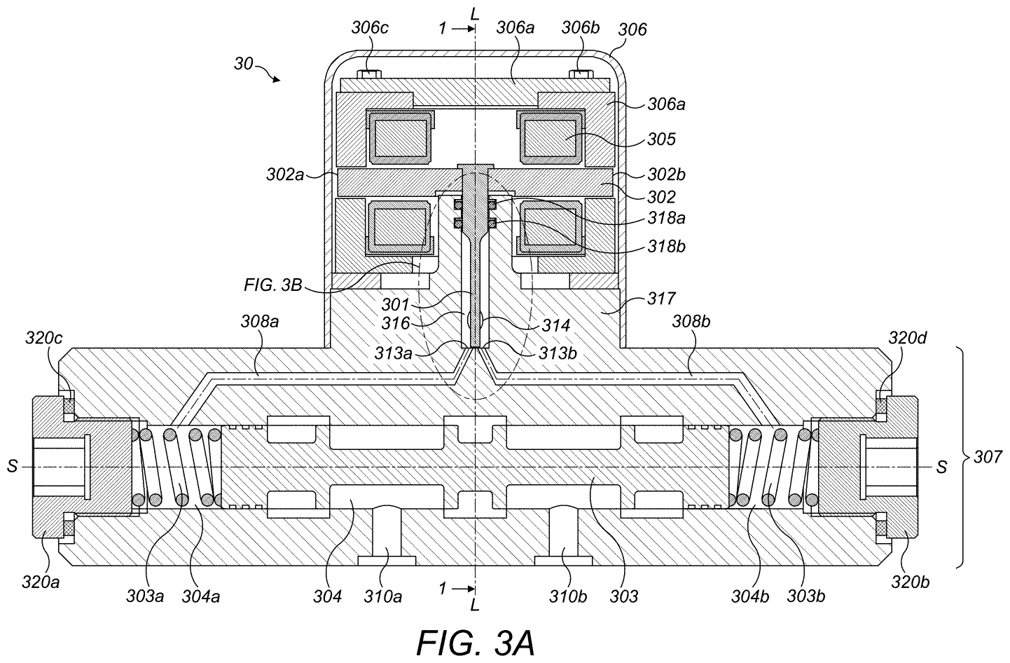

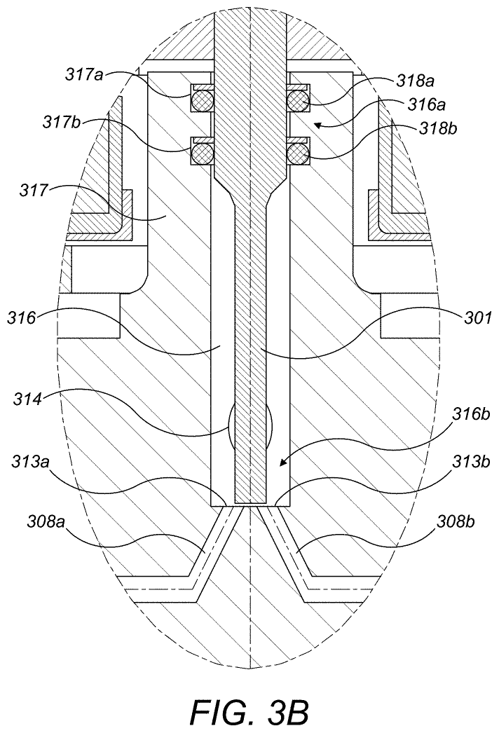

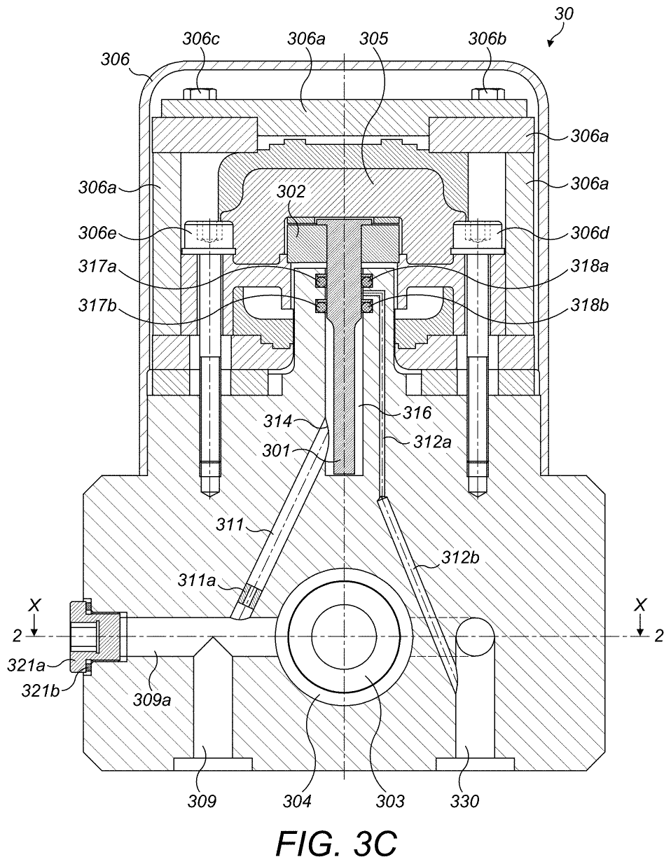

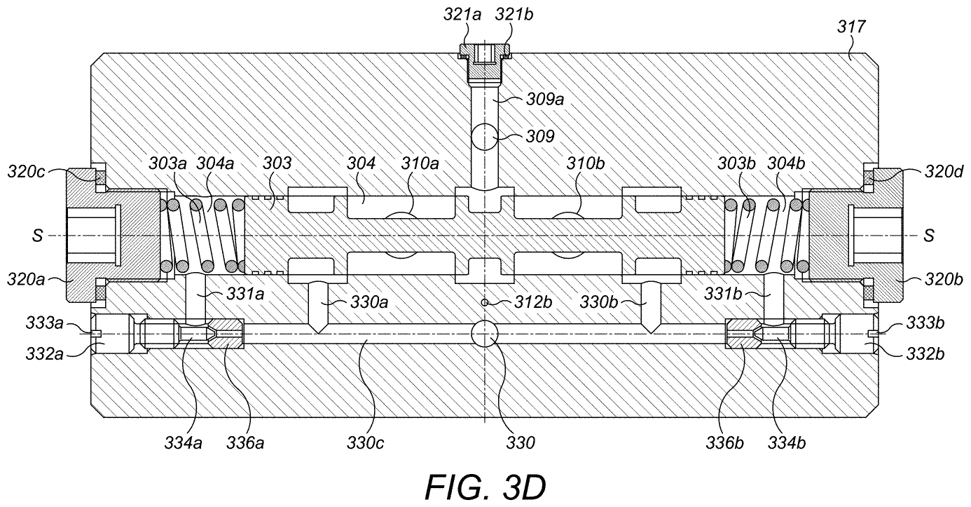

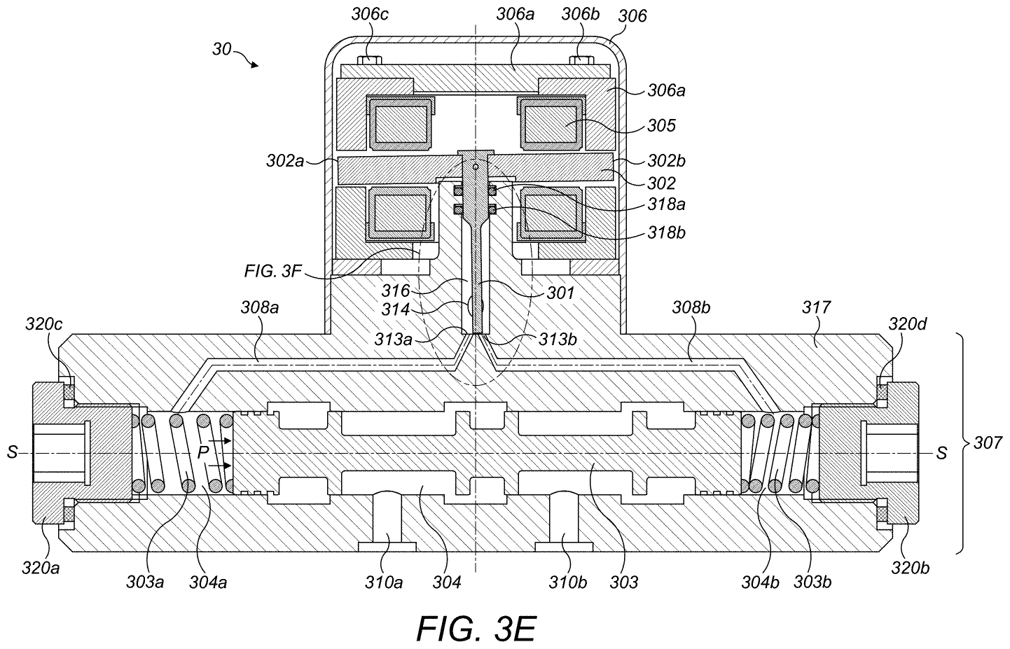

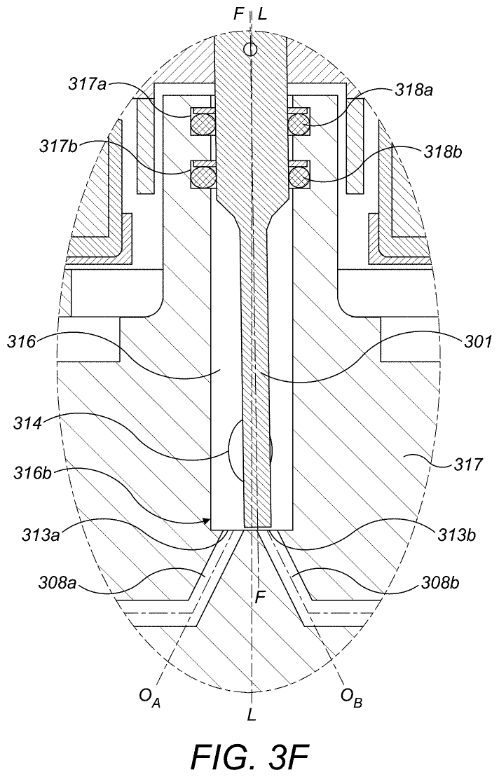

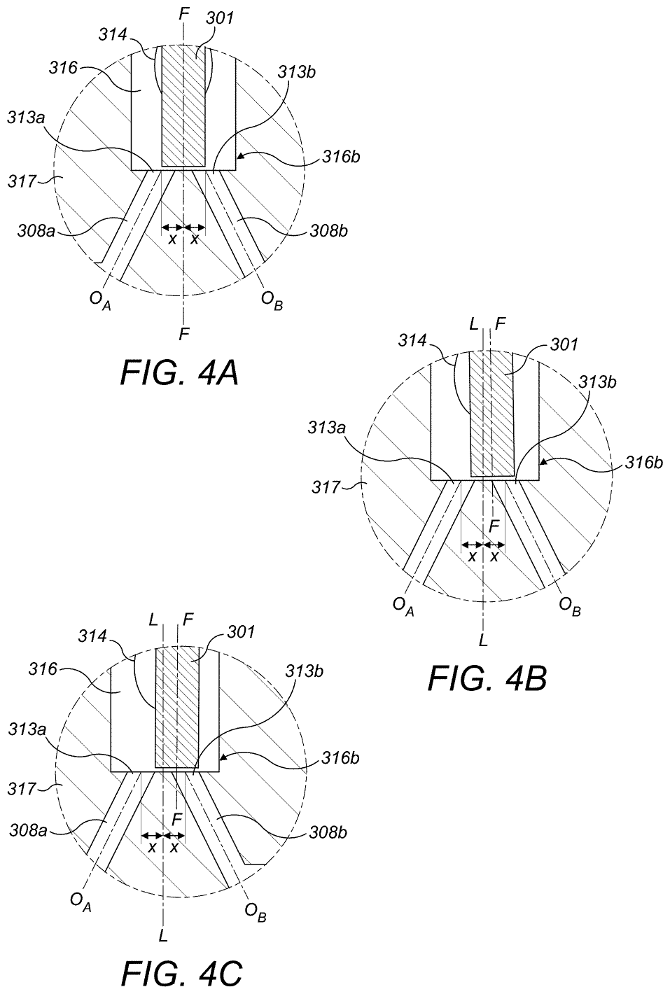

FIGS. 3A to 4C show a hydraulic servo valve 30 in accordance with an embodiment of the present disclosure. The hydraulic servo valve 30 shown in FIGS. 3A to 4C replaces the jet pipe arrangement of FIG. 1 and the flapper and nozzle arrangement of FIG. 2 with an alternative means of moving a spool 303.

In the embodiments of FIGS. 3A to 4C, the servo valve 30 comprises a flapper 301 (i.e. flapper arm). The flapper 301 is disposed in a fluid injection cavity 316. Fluid injection cavity 316 is a substantially cylindrical cavity disposed in a servo valve body 317, and it extends along a longitudinal axis L-L of the servo valve 30. Flapper 301 is movable (e.g. rotatably from left to right in as shown in FIGS. 3A to 4C—i.e. perpendicular to longitudinal axis L-L) within the fluid injection cavity 316. The flapper 301 may also, or alternatively bend so as to move an end portion of the flapper in the same direction (as shown in, e.g., FIGS. 4A-4C).

The servo valve 30 comprises an electromagnet 305 and armature 302 connected to the flapper 301 in the same manner as discussed in relation to FIG. 2, and like features have been represented with the same numeral, but prefixed with “3xx” instead of “2xx”. When the electromagnet 305 is activated the magnetic biasing of the armature tips 302a, 302a causes rotation of the flapper 301 in the fluid injection cavity 316.

In the depicted embodiment, the armature 302 and the electromagnet 305 are disposed within a housing 306 that is coupled to the servo valve body 317, and are supported therein via attachment to a supporting frame 306a and fasteners 306b-306e.

Fluid is supplied to the cavity 316 by a fluid injection opening 314 (or more than one) that is connected to a fluid supply pressure inlet 309 via supply lines 309a and 311 in the servo valve body 317. Supply line 309a is sealed from the exterior of the servo valve body 317 when in use by a cap 321a that has an O-ring seal 321b disposed there around. Cap 321a and O-ring seal 321b are also configured to be removable from the supply line 309a (e.g. via threaded engagement or interference fit with the servo valve body 317) for assembly and maintenance purposes.

Cavity 316 is fluidically isolated from the armature 302 and the electromagnet 305 by seals 318a, 318b, that are positioned at a first axial end 316a of the cavity 316, proximate the armature 302. Seals 318a, 318b are disposed around the flapper 301 in annular recesses 317a, 317b in the servo valve body 317, and prevent fluid from the cavity 316 being communicated to the armature 302 and electromagnet 305 (e.g. by passing around the flapper 301). Seals 318a, 318b may be any suitable type of seal e.g. a ring seal or a bearing seal.

Referring to FIG. 3C, a fluid drainage line 312a is disposed (axially) between the seals 318a, 318b. Fluid drainage line 312a is disposed within the servo valve body 317, and is connected to a fluid return line 312b, and in-turn a fluid return port 330, that allows communication of supply fluid to a return circuit (not shown). Is this manner, fluid drainage line 312a allows supply fluid from the cavity 316 that manages to bypass seal 318b to be drained back into the fluid return circuit, before it has a chance to bypass seal 318a and egress into the armature 302 and electromagnet 305 arrangement. This ensures the servo valve 30 does not lose operating fluid pressure, and prevents the armature 302 and electromagnet 305 from being damaged by hydraulic fluid.

As also shown in FIG. 3C, a control orifice 311a may be provided in the supply line 311. The control orifice 311a provides a constriction in the supply line 311 that allows calibration of the degree of spool movement for a given pressure imbalance. Control orifices can also be provided in the drainage line 312a, return line 312b, or any other part of the return circuit for the same purposes, and will be discussed in more detail below, when referring to FIG. 3D.

At a second axial end 316b of the cavity 316 (opposite the first axial end 316a) there are two receivers 308a, 308b forming respective openings 313a, 313b into the cavity 316 that allow communication of supply fluid pressure from the cavity 316 to the spool 303. In the depicted embodiment, the openings 313a, 313b are both spaced an equal and opposite distance from the longitudinal axis L-L of the servo valve 30 in a direction perpendicular thereto, which corresponds to the longitudinal axis F-F of the flapper 301 when it is in the neutral position. For example, as shown in FIGS. 4A to 4C, the central axis O_{A}, O_{B} of each opening 313a, 313b is spaced an equal distance X from the longitudinal axis F-F, in a direction perpendicular to the longitudinal axis F-F. As will be discussed in more detail below, the flapper 301 is selectively moved (e.g. bended and/or rotated) to vary how much fluid pressure is communicated to each of the openings 313a, 313b and receivers 308a, 308b.

By spacing the openings 313a, 313b equally apart perpendicularly relative to the longitudinal axis F-F of the flapper 301 when it is in a neutral position, a linearly varying pressure imbalance due to flapper rotation 301 (discussed in more detail below) can be provided.

In the same manner as the receivers 108a and 108b of FIG. 1 discussed above, receivers 308a and 308b are in fluid communication with chambers 304a and 304b of a spool portion 307 of the servo valve 30. A spool 303 is disposed in a spool cavity 304, and is in fluid communication and movable between chambers 304a and 304b along a spool axis S-S. In addition to the receivers 308a, 308b and the spool 303, the spool portion 307 of the servo valve 30 also includes respective springs 303a, 303b in chambers 304a and 304b, which provide a bias on the spool 303 back towards a neutral position. In this manner, springs 303a, 303b can help meter the spool 303 movement and force it to return to the neutral position when pressure imbalances in the 320b having O-ring seals 320c, 320d disposed there around. Caps 320a, 320b and O-ring seals 320c, 320d serve to seal the chambers 304a, 304b from the exterior of the servo valve 30 when in use, but are also configured to be removable therefrom (e.g. via threaded engagement or interference fit with the servo valve body 317) for assembly and maintenance purposes.

As shown in FIG. 3D, the spool portion 307 further comprises a series of return lines 330a, 330b, 330c, 331a, 331b disposed in the servo valve body 317 that permit fluid communication from the spool cavity 304 and chambers 304a, 304b to the return port 330. This allows communication of supply fluid used to move the spool 307 to the return circuit (not shown). Spool cavity return lines 330a and 330b allow fluid communication between the spool cavity 304 and the return port 330 via the return line 330c. Chamber return lines 331a and 331b allow fluid communication between the spool chambers 304a and 304b and the return port 330 via the return line 330c.

Downstream of each of the chamber return lines 331a, 331b there is a nozzle 334a, 334b and control orifice 336a, 336b arrangement (as briefly discussed above in relation to FIG. 3C). The nozzles 334a and 334b deliver fluid through the control orifices 336a and 336b to return line 330c, and define a constriction at the outlet of each nozzle 334a, 334b that can be used to adjust the degree of spool movement for a given pressure imbalance (as discussed above in relation to FIG. 3C).

The size of the constriction provided by the nozzles 334a, 334b and orifices 336a, 336b can be adjusted and is set before during initial servo valve calibration i.e., before operational use. For example, the installer of the servo valve 30 can have a set of nozzles of varying inner diameter/outlet size that can be inserted into the orifices 336a, 336b to achieve a desired constriction size. Alternatively, a nozzle with an adjustable opening size may be inserted into the orifices 336a, 336b. As the skilled person will understand, the constriction size necessary would be known depending on the design and operating requirements of a particular servo valve for a particular application and operating environment.

The nozzles 334a, 334b may be held in the orifices 336a, 336b, for instance, by threaded engagement or press-fit. In the depicted embodiment, screws 332a and 332b are used to push and hold the nozzles 334a, 334b in place against the orifices 336a, 336b. Screws 332a and 332b are threadably engaged to the servo valve body 317 and they can be removed or their positioning adjusted using screw heads 333a, 333b and a screw driver (not shown).

In the same manner as the jet pipe arrangement of FIG. 1 discussed above, the spool portion 307 also features outlets 310a and 310b that are in fluid communication with an actuator (not shown) downstream. The outlets 310a and 310b allow communication of pressure imbalances from the spool potion 307 to the actuator, in order to control actuator movement. As will be understood by the skilled person, any suitable hydraulic actuator may be used.

As shown in FIGS. 3A, 3B and 4A, when a neutral spool position is required, the flapper 301 is positioned centrally between the receiver openings 313a and 313b, such that each receiver 308a, 308b communicates an equal proportion of fluid pressure to the chambers 304a and 304b.

As shown in FIGS. 3E, 3F, 4B and 4C, when movement of the actuator is required, the flapper 301 is rotated within the cavity 316 perpendicular to axis L-L (by activation of the electromagnet 305 and armature 302—as discussed above), such that one of the receiver openings 313a, 313b is more occluded than the other (in the depicted example flapper 301 is moved to occlude opening 313b more so than opening 313a). In this manner, the less occluded opening receives a higher fluid pressure from the fluid in the cavity 316 supplied by the injection opening 314 than the opening that is more occluded by the flapper 301. This generates a pressure imbalance. This pressure imbalance is communicated to the chambers 304a and 304b via the receivers 308a, and 308b, which causes the spool 303 to be moved accordingly (in the depicted example spool 303 is accordingly moved to the right along spool axis S-S, as shown by arrows P), and in turn move the actuator (as discussed above).

The degree of pressure imbalance imparted to the spool 303 (and thus amount of actuator movement) can be adjusted by controlling the degree of flapper 301 rotation. For instance, as shown in FIGS. 4B and 4C, flapper 301 can be rotated relative to the longitudinal axis L-L of the servo vale 30 by a small amount R₁ to only slightly occlude the opening 313b, or can be rotated a larger amount R₂ to fully occlude the opening 313b. Although FIG. 4B only shows the R₁ position, it is to be understood that flapper 301 rotation can be varied continuously between the neutral position (e.g. in FIG. 4A) and the maximum rotation position (i.e. can be of any amount below the maximum rotation position).

In the depicted embodiment, the maximum allowed rotation of the flapper 301 is set to correspond to the distance R2, which corresponds to an amount that fully occludes the opening 313b and fully opens the opening 313a to cavity 316. This allows the maximum flapper 301 rotation to provide the maximum spool 303 and actuator movement available. However, depending on the sensitivity and range of actuator movement needed in a particular application, the maximum rotation range of the flapper 301 can be adjusted accordingly.

As will be appreciated when looking at FIG. 3E, it may be necessary to limit the range of rotation of the flapper 301 such that it doesn't contact the cavity 316 walls, or such that the armature 302 does not make contact with the frame 306a supporting the electromagnet 305. This is because such contact could damage the flapper 301 and the armature 302.

The amount of flapper 301 rotation is controlled by the amount of current supplied to the electromagnet 305. For instance, supplying a larger current will produce a larger torque on armature 302, and therefore produce a larger rotation of flapper 301. Thus, the maximum amount of flapper 301 rotation can be decided by limiting the current supplied to the electromagnet 305. Any amount of flapper 301 rotation between the neutral and maximum rotation positions can be produced by providing an appropriate amount of current below that needed to provide maximum flapper 301 rotation. The direction of flapper 301 rotation can also be changed by reversing the polarity of the current (i.e. reversing the direction of torque supplied to the armature 302 by the electromagnet 305—as discussed above in relation to FIG. 1). Furthermore, the amount of rotation necessary to occlude and open the openings 313a and 313b can be adjusted by spacing the openings 313a and 313b further apart or closer together.

In this manner, the operating currents and frequencies of the servo valve 30 can be fully adjusted to suit a particular application. For example, a higher frequency response and more energy efficient servo valve 30 may be realised by reducing the maximum current supplied to the electromagnet 305 to reduce the range of flapper 301 rotation and moving openings 313a and 313b closer together to ensure the full range of actuator movement is still available.

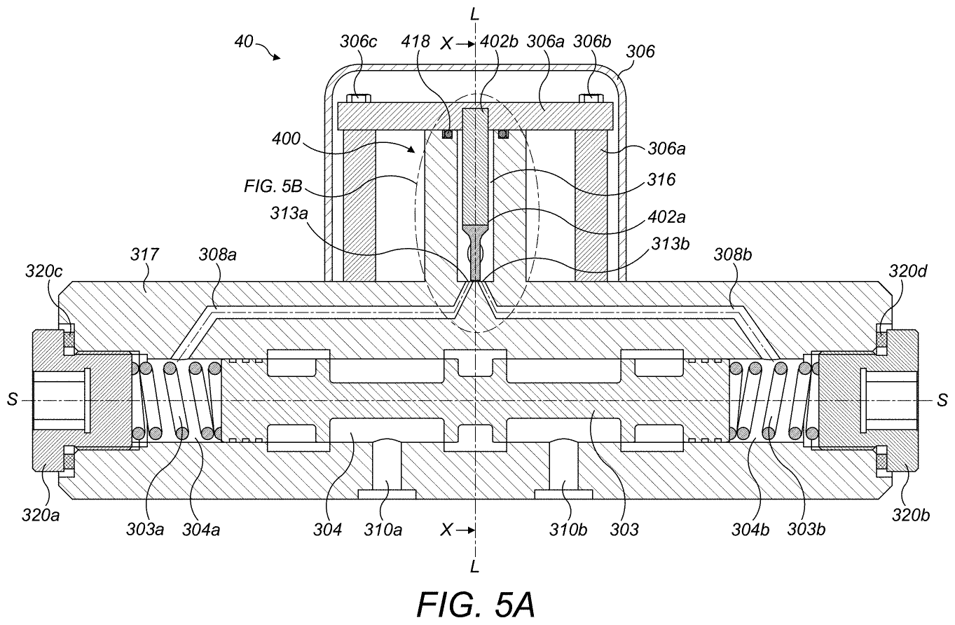

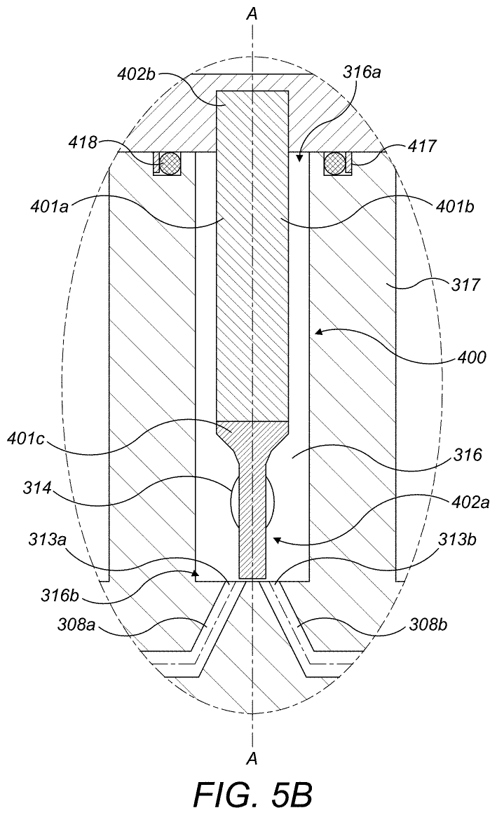

FIGS. 5A and 5B show an example of an alternative embodiment of a hydraulic servo valve 40 in accordance with the present disclosure. Servo valve 40 differs from the embodiments of servo valve 30 shown in FIGS. 3A to 4C only in that the flapper 301 and the associated armature 302 and electromagnet 305 components have been replaced with a piezoelectric element 400.

The piezoelectric element 400 is disposed in the cavity 316 and configured to interact with the openings 313a and 313b in the same manner as the flapper 301 of FIGS. 3A to 4C. The piezoelectric element 400 is configured such that an application of voltage thereto will result in a bending of the piezoelectric element 400 to effectively rotate the piezoelectric element 400 relative to the longitudinal axis L-L, and thus, selectively open or occlude the openings 313a and 313b. Exemplary embodiments of such piezoelectric element 400 configurations are discussed below in relation to FIGS. 5A and 5B. However, it is to be understood that many different piezoelectric element 400 configurations that result in the aforementioned bending and rotation can be conceived, and therefore, the piezoelectric element 400 of the present disclosure is not to be limited to such specific embodiments.

In various embodiments, the piezoelectric element 400 is a piezoelectric bimorph 400. Piezoelectric bimorphs are known, and can be used to provide a cantilevered element that can be bent due to the application of an electrical signal (e.g. voltage) thereto.

Typically, a piezoelectric bimorph comprises a first piezoelectric material layer sandwiched to a second non-piezoelectric material layer. Applying a voltage to the first piezoelectric material layer will cause it to change dimension (e.g. length). The second material layer must then deform to accommodate the dimensional change in the first material layer (in a similar manner to a bimetallic strip). If the bimorph is cantilevered at one end, this deformation results in a bending motion. The embodiments discussed below, exploit this bending motion. If the bending deformation is under the elastic limit of the material layers, then the material layers will return back to their original shape, once the voltage is removed.

In certain bimorph designs, a second piezoelectric material layer can be used, instead of the non-piezoelectric material layer. The second piezoelectric material layer can be wired in reverse to the first piezoelectric material layer, such that application of a voltage to the bimorph results in an increase in length of one of the layers and a decrease in length of the other. This likewise produces a bending deformation. Alternatively, instead of piezoelectric material layers, the bimorph could use two piezoelectric actuators. It is also known that other material layers may be present in between and/or around the first and second material layers in either of the above bimorph designs.

In the depicted embodiment of FIGS. 5A and 5B, piezoelectric bimorph 400 comprises two material layers 401a and 401b that extend to form a blocking portion 401c, and which are disposed in the cavity 316. The layers 401a, 401b extend parallel to each other along a longitudinal axis A-A of the bimorph 400, and contact each other along this axis A-A (i.e. such that the layers 401a and 401b are a mirror image of each other—or are “sandwiched together”). The blocking portion 401c extends axially towards the openings 313a and 313b at a first axial end 402a of the bimorph 400, and is configured to interact with the openings 313a and 313b in the same manner as the flapper 301 discussed above in relation to FIGS. 3A to 4C. Accordingly, instead of being spaced apart relative to the flapper axis F-F, the openings 313a and 313b of this embodiment are spaced apart relative to the axis A-A.

Although the depicted blocking portion 401c has been shaped to be thinner near the openings 313a and 313b, within the scope of this disclosure, the blocking portion 401c is only defined as the portion of the material layers 401a, 401b that is used to interact with the openings 313a and 313b, and can take any suitable shape (e.g. it may not be shaped differently to the rest of the layers 401a and 401b at all).

The bimorph 400 is fixedly coupled to the support plate 306a at a second axial end 402b thereof, opposite the first axial end 402a. In this manner, bimorph 400 forms a cantilever extending from the support plate 306a.

As discussed above, first and second material layers 401a and 401b can be a combination of a piezoelectric material layer and a non-piezoelectric material layer, or a combination of two piezoelectric material layers. In addition, within the scope of the present disclosure, additional material layers may be present in between or around the layers 401a and 401b when they are sandwiched together.

The material layers 401a and 401b are connected to an electrical input (not shown), and as discussed above, the application of voltage thereto will result in a change in dimension to the piezoelectric material layer(s) thereof. The piezoelectric material layer(s) are configured to either lengthen or shrink in the axial direction (i.e. parallel to the longitudinal axis A-A) in response to the voltage. This will result in the bimorph 400 undergoing a bending deflection that will cause an effective rotation of the blocking portion 401c relative to the openings 313a and 313b. In this manner, varying the amount of voltage used to energise the bimorph 400 can be used to control the rotation of the blocking portion 401c and thus, control the degree of spool 303 and actuator movement, in the same way as the embodiments of FIGS. 3A to 4C discussed above.

The degree of bending can be varied by the amount of voltage used to energise the bimorph 400. In this manner, the maximum rotational range of the blocking portion 401c can be set by having a maximum voltage that corresponds to the maximum desired rotation (in a similar manner to the flapper 301 discussed above). A continuous and linear adjustment of the voltage supplied to the bimorph 400 can also be used to result in a continuous, linear increase or decrease in the bending deformation thereof, and subsequently in the force applied to the actuator.

The piezoelectric material layer(s) may be comprised of any suitable piezoelectric material and/or may be any suitable piezoelectric actuator (e.g. a piezoelectric stack). Such piezoelectric materials and actuators are well-known, and therefore specific embodiments thereof do not warrant further discussion.

As shown in FIGS. 5A and 5B, a seal 418 is disposed in an annular recess 417 at the first axial end 316a of the cavity 316, and is configured to provide a fluid tight seal between the servo valve body 317 and the support plate 306a. This prevents fluid in cavity 316 from leaking out of the cavity 316 to the exterior of the servo valve body 317 and potentially damaging the electrical inputs (not shown) for the piezoelectric element 400. It also ensures operational fluid pressure is not lost through leakage. Seal 418 may be any suitable seal, such as a ring seal or a bearing seal.

Although seal 418 is depicted as a single seal, it is to be noted that the double axially spaced seal arrangement of seals 318a and 318b discussed in relation to FIGS. 3A to 4C may also be utilised in the embodiments of FIGS. 5A and 5B. Likewise, the drainage line 312a and return line 312b linked thereto may also be utilised in these embodiments.

It is to be appreciated that by replacing the jet pipe and flapper and nozzle arrangements of the prior art with the embodiments of the present disclosure, a more compact servo valve can be realised, which reduces weight, size and complexity. Such reductions in weight and size are particularly advantageous in aerospace applications. In addition, the embodiments of the present disclosure may overcome the aforementioned frequency and operating pressure limitations of the prior art arrangements. The embodiments of the present disclosure may also be able to allow a linear force adjustment of the actuator.

In particular, the use of the piezoelectric element 400 in place of an armature 302 and flapper 301 arrangement, may allow for a particularly compact and lightweight servo valve 40, that can also make finer and more accurate adjustments (i.e. is more sensitive and responsive).

1. A hydraulic servo valve, comprising:
a fluid injection cavity;
at least one fluid injection opening disposed in the cavity and configured to supply fluid to the cavity;
a pair of fluid receiving openings configured to receive fluid from the cavity; and
a member disposed in the cavity between the pair of openings;
wherein the member is bendable and/or rotatable relative to a longitudinal axis (L-L) of the cavity in order to selectively, and at least partially open or occlude each of the openings.

2. The hydraulic servo valve of claim 1, wherein the member comprises a flapper connected and extending perpendicular to an armature, and the servo valve further comprises an electromagnet surrounding the armature;
wherein electrical energisation of the electromagnet produces a torque on the armature to bend and/or rotate the flapper.

3. The hydraulic servo valve of claim 1, wherein the member comprises a piezoelectric element, and electrical energisation of the piezoelectric element is configured to bend the element.

4. The hydraulic servo valve of claim 3, wherein the piezoelectric element comprises a piezoelectric bimorph.

5. The hydraulic servo valve of claim 4, wherein the bimorph is cantilevered at an axial end thereof.

6. The hydraulic servo valve of claims 4, wherein the bimorph comprises a first material layer and a second material layer sandwiched together, the first material layer comprising a piezoelectric material, and the second material layer comprising one of a piezoelectric material or a non-piezoelectric material.

7. The hydraulic servo valve of claim 4, wherein the piezoelectric element comprises a first piezoelectric actuator extending axially parallel to a second piezoelectric actuator, wherein, for example, the first and second piezoelectric actuators are piezoelectric stacks.

8. The hydraulic servo valve of claim 1, wherein the servo valve further comprises at least one seal positioned between a body of the servo valve and the member to prevent fluid escaping the cavity.

9. The hydraulic servo valve of claim 8, wherein the at least one seal comprises a pair of seals disposed in the cavity and spaced axially apart relative to the longitudinal axis (L-L) of the cavity.

10. The hydraulic servo valve of claim 9, wherein the servo valve further comprises:
a drainage line disposed axially between the seals;
wherein the drainage line is configured to drain any fluid that is caught between the pair of seals.

11. A method of controlling an actuator using the hydraulic servo valve of claim 1, the method comprising:
supplying fluid to the cavity via the at least one injection opening;
communicating the fluid to the fluid receiving openings;
bending and/or rotating the member in order to establish a pressure imbalance between the fluid communicated to each of the fluid receiving openings; and
communicating the pressure imbalance to an actuator, in order to control movement of the actuator.

12. The method of claim 11, wherein the step of communicating the pressure imbalance to an actuator comprises:
communicating the pressure imbalance to a spool (303) located within a spool cavity (304) and between a first spool chamber (304a) and a second spool chamber (304b);
wherein:
the first spool chamber and the second spool chamber are of varying volume based on the position of the spool within the spool cavity; and
the pressure imbalance varies the position of the spool to generate a pressure imbalance in the spool cavity; and
communicating the pressure imbalance from the spool cavity to the actuator.

13. The hydraulic servo valve of claim 1, further comprising:
a spool located within a spool cavity and between a first spool chamber and a second spool chamber, wherein the first spool chamber and the second spool chamber are of varying volume based on the position of the spool within the spool cavity;
a supply pressure inlet; and
a supply line connecting the supply pressure inlet to the at least one injection opening;
wherein each opening is fluidly connected to a respective one of the first and second spool chambers, such that, in use, when the member is bended and/or rotated, the spool moves within the spool cavity to vary the volume of the first and second spool chambers in response to fluid pressure communicated from the openings.
